(19) United States
(12) Patent Application Publication
(10) Pub. No.: US 2025/0006007 A1
(43) Pub. Date: Jan. 2, 2025

(54) EQUITY-BASED BONUS COMMUNITY GAMING SYSTEMS AND METHODS

(71) Applicant: Aristocrat Technologies, Inc., Las Vegas, NV (US)

(72) Inventors: Patricia Crescenzo, Chicago, IL (US); Joseph Masinter, II, Las Vegas, NV (US); Alfred Thomas, Ventura, CA (US)

(21) Appl. No.: 18/596,392

(22) Filed: Mar. 5, 2024

Related U.S. Application Data
(60) Provisional application No. 63/524,086, filed on Jun. 29, 2023.

(51) Int. Cl. G07F 17/32; G07F 17/34

(52) U.S. Cl. CPC G07F 17/3267; G07F 17/3213; G07F 17/3258; G07F 17/34

(57) ABSTRACT

An electronic gaming machine (EGM) is disclosed. The EGM includes a game controller configured to: (i) receive a credit input from a player for a base game; (ii) in response to receiving an input for initiating the base game, cause to be displayed a plurality of symbols on a plurality of reels in a first section of a display device; (iii) based upon an amount of the credit input, award a time period for the player to qualify for participating in a community bonus game; (iv) in response to at least one trigger symbol being displayed on the plurality of reels before the time period has expired, trigger the community bonus game; and (v) in response to triggering of the community bonus game, cause a community bonus game display area to be created from a second section of the display device being linked with other EGMs.

### CROSS-REFERENCE TO RELATED APPLICATION

This application claims priority to and the benefit of U.S. Provisional Patent Application Ser. No. 63/524,086, entitled “EQUITY-BASED BONUS COMMUNITY GAMING SYSTEMS AND METHODS,” filed Jun. 29, 2023, and the content of which is incorporated herein in its entirety for all purposes.

### TECHNICAL FIELD

The field of disclosure relates generally to electronic gaming machines, and more specifically, to systems and methods of awarding equity-based bonus awards to players of electronic community games even after a player exits a current instance of the game.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency, or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, an electronic gaming machine (EGM) of a plurality of EGMs is disclosed. The EGM includes a display device, an interface device coupling the EGM with other EGMs of the plurality of EGMs and an electronic gaming server, a memory device storing instructions, and a game controller. The game controller includes a processor configured to execute the instructions stored in the memory device, which, when executed, cause the game controller to: (i) receive a credit input from a player for a base game; (ii) in response to receiving an input for initiating the base game, cause to be displayed a plurality of symbols on a plurality of reels, the plurality of symbols displayed in a first section of the display device; (iii) based upon an amount of the credit input, award a time period for the player to qualify for participating in a community bonus game; (iv) in response to at least one trigger symbol being displayed on the plurality of reels before the time period has expired, trigger the community bonus game; (v) in response to triggering of the community bonus game, cause a community bonus game display area to be created by linking with the other EGMs of the plurality of EGMs. The community bonus game display area is created from a second section of the display device of each EGM of the plurality of EGMs, the second section of the display device of each EGM of the plurality of EGMs including a predefined number of symbol positions.

In another aspect, a computer-implemented method is disclosed. The computer-implemented method includes (i) receiving a credit input from a player for a base game at an electronic gaming device, the electronic gaming device is coupled with other electronic gaming devices of a plurality of electronic gaming devices via an interface device; (ii) in response to receiving an input for initiating the base game, causing to be displayed a plurality of symbols on a plurality of reels, the plurality of symbols displayed in a first section of a display device of the electronic gaming device; (iii) based upon an amount of the credit input, awarding an energy for accrual for the player to qualify for participating in a community bonus game; (iv) in response to at least one trigger symbol being displayed on the plurality of reels before the accrued energy has diminished below a threshold value, triggering the community bonus game; and (v) in response to triggering of the community bonus game, causing a community bonus game display area to be created by linking with the other electronic gaming devices of the plurality of electronic gaming devices. The community bonus game display area is created from a second section of the display device of each electronic gaming device of the plurality of electronic gaming devices. The second section of the display device of each electronic gaming device of the plurality of electronic gaming devices includes a predefined number of symbol positions.

In yet another aspect, an electronic gaming application server communicatively coupled with a plurality of electronic gaming machines (EGMs) is disclosed. The electronic gaming application server includes a memory device storing instructions, at least one random number generator (RNG), and a game controller. The game controller includes a processor configured to execute the instructions stored in the memory device, which, when executed, cause the game controller to (i) in response to receiving an input for initiating a base game at an electronic gaming device of the plurality of electronic gaming devices, cause to be displayed a plurality of symbols on a plurality of reels, the plurality of symbols displayed in a first section of a display device of the electronic gaming device; (ii) based upon an amount of credit input received from a player at the electronic gaming device, cause awarding of an energy for accrual for the player to qualify for participating in a community bonus game; (iii) in response to at least one trigger symbol being displayed on the plurality of reels before the accrued energy has diminished below a threshold value, cause triggering of the community bonus game; and (iv) in response to triggering of the community bonus game, cause a community bonus game display area to be created by linking with the other electronic gaming devices of the plurality of electronic gaming devices. The community bonus game display area is created from a second section of the display device of each electronic gaming device of the plurality of electronic gaming devices, where the second section of the display device of each electronic gaming device of the plurality of electronic gaming devices includes a predefined number of symbol positions.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 illustrates a set of electronic gaming machines (EGMs) configured to execute a community gaming game with a bonus game and display the bonus game, in accordance with some embodiments.

FIGS. 5A and 5B illustrate transition of an EGM from a base game play to a bonus game displayed on display devices of a set of EGMs, in accordance with some embodiments.

FIG. 6 illustrates an exemplary flow-chart of method operations performed by an EGM, in accordance with some embodiments.

### DETAILED DESCRIPTION

Generally, in conventional bonus gaming systems and methods available in electronic gaming machines (EGMs), a payout of a player's equity (e.g., investment in the game through wagers) in a particular game may happen later during game play, and most likely in a form of a progressive jackpot. In these conventional bonus gaming systems, however, while a potential payout keeps increasing along with the player's equity in the game, until the jackpot is won, a player's identifying data and previous gaming activities are not saved in the system. And, therefore, once the player leaves the EGM, the player is no longer eligible to participate in the progressive jackpot. In other words, in these knowns systems, the player is only able to collect on their equity in the game, when the player continues to play; and if the player stops playing the game, then they lose out on that equity in the game. Thus, only current, and future players are eligible to participate in and potentially win the progressive jackpot. Players' inability to keep the equity that they have built-up in the game upon leaving the EGM, and essentially losing out on their equity in a game, can create frustrations among players.

Bonus gaming systems and methods, as described in the present disclosure, instead provide players an opportunity to participate in a progressive jackpot even if they decide to exit from current game play or the current instance of the game. In particular, the bonus gaming systems and methods, as described herein, include a player and the player's identifying data and game play data related to gaming activities (e.g., the player's equity) on the EGM being saved, and thereby, enabling the player to participate in the progressive jackpot during a bonus game after the player has left the game of the EGM.

In other words, the bonus gaming systems and methods, as described herein, allow past players (e.g., players who have exited from the current instance of the game) who have contributed to the equity of the game play, an opportunity to win, in some cases, a part of the progressive jackpot or the full progressive jackpot. The equity of the player may be combined with equity of other players, and each player may therefore have an opportunity to win none, some part of, or a full amount of the combined equity during the progressive jackpot bonus game. Each player may be awarded none, some part of, or a full amount of the combined equity in accordance with an RNG.

Accordingly, various embodiments, as described herein, overcome disadvantages associated with the conventional bonus gaming systems and methods available in electronic gaming machines (EGMs) by providing additional opportunities to players to participate and win the progressive jackpot. Additionally, or alternatively, various embodiments corresponding to bonus gaming systems and methods, as described in the present disclosure, may provide an increased RTP and may provide community-based gaming awards to players that are more representative of the equity that each player has actually included in the community award.

The embodiments of the present disclosure represent a technical improvement in the art of electronic gaming devices, machines, systems, and operations of such electronic gaming devices or systems. Technical improvements represented by the present disclosure include at least using an RNG to randomly determine symbols for displaying in each symbol position during a game instance and evaluating for one or more winning combinations to award a player, and for triggering a feature game (or bonus game) of free game instances. During a free game instance, the player may win according to a symbol that lands in a symbol position that is assigned to the player during a feature game instance of a community bonus game. Players of the community bonus game are current and past players who have their assigned time period that is not yet expired, or accrued energy that has not diminished below. Accordingly, players who are not at their respective electronic gaming device when a bonus game is triggered may still play during the community bonus game. Players and their time period or accrued energy for qualifying for the community bonus game are stored in memory so that they are persistent through the game play, and those players may be notified when the community bonus game is triggered. Further, a position for each qualified player during the community bonus game on community bonus display areas is randomly determined using an RNG and each player is awarded based upon a symbol landing in the position assigned to the player. Accordingly, the embodiments of the present disclosure allow players to leave and join the gaming with other players in a community bonus game, where each player is awarded based on a bet multiplier according to an initial credit input received from the player. Additionally, the embodiments present a technical improvement in which community bonus display areas are created by linking a section of a display device of each electronic gaming device. Further, embodiments of the present disclosure also improve an amount of data storage and use of computation resources by designating and updating an award value based upon a bet multiplier that is determined according to a credit input received by the player for initiating the base game.

The technical problems addressed herein include at least one of: (i) inability of known systems to persistently track and identify past players as qualifying players during a community bonus game; (ii) inability of known systems to efficiently communicate how much accrued time or energy is available to a player to qualify for the community bonus game; and (iii) inability of known systems to improve an amount of data storage and use of computation resources by designating and updating award value based upon a bet multiplier according to a credit input received by the player during the community bonus game.

The resulting technical effects and/or technical benefits achieved by this disclosure include at least one of: (i) ability to persistently track and identify past players as qualifying players during a community bonus game; (ii) ability to efficiently communicate how much accrued time or energy is available to a player to qualify for the community bonus game; and (iii) ability to improve an amount of data storage and use of computation resources by designating and updating award value based upon a bet multiplier according to a credit input received by the player during the community bonus game.

Various interface improvements are provided herein to efficiently and effectively communicate information. For instance, energy or time period available to a player to qualify for a community bonus game is displayed using animation.

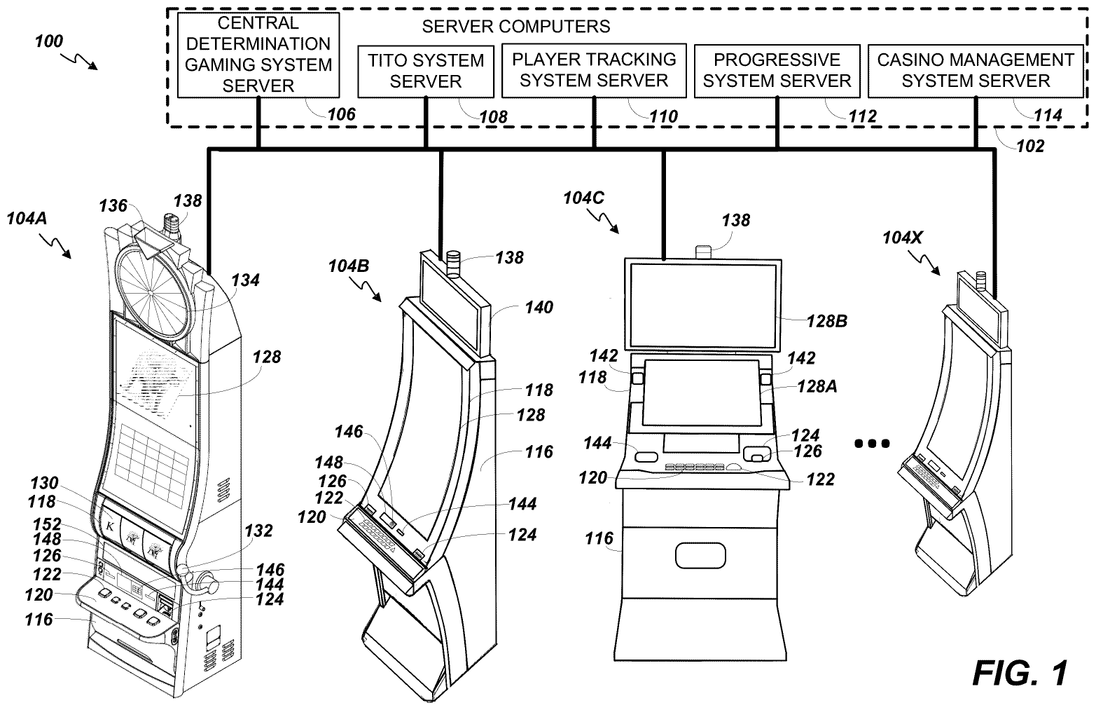

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

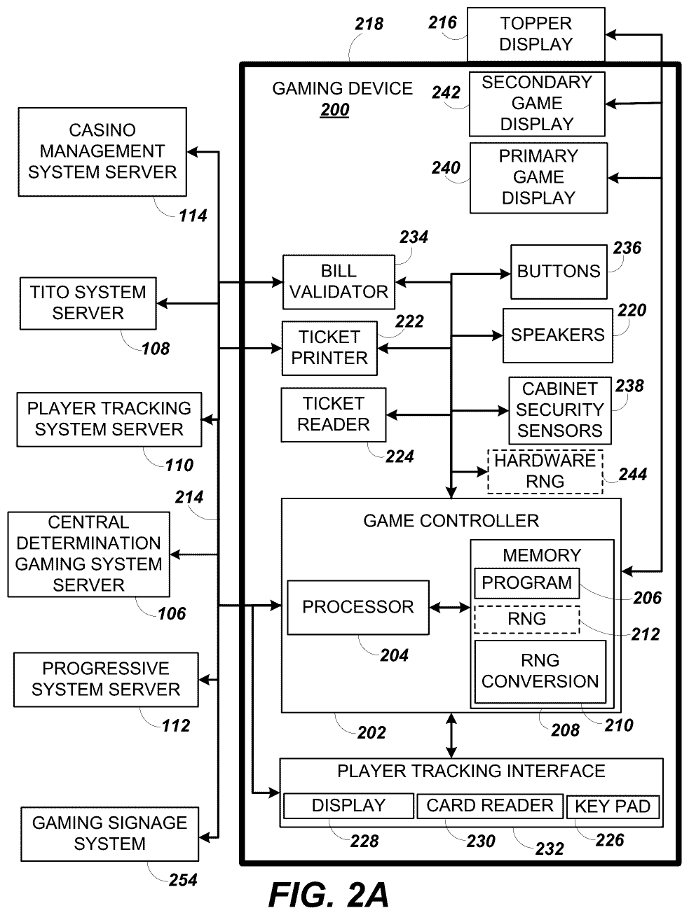

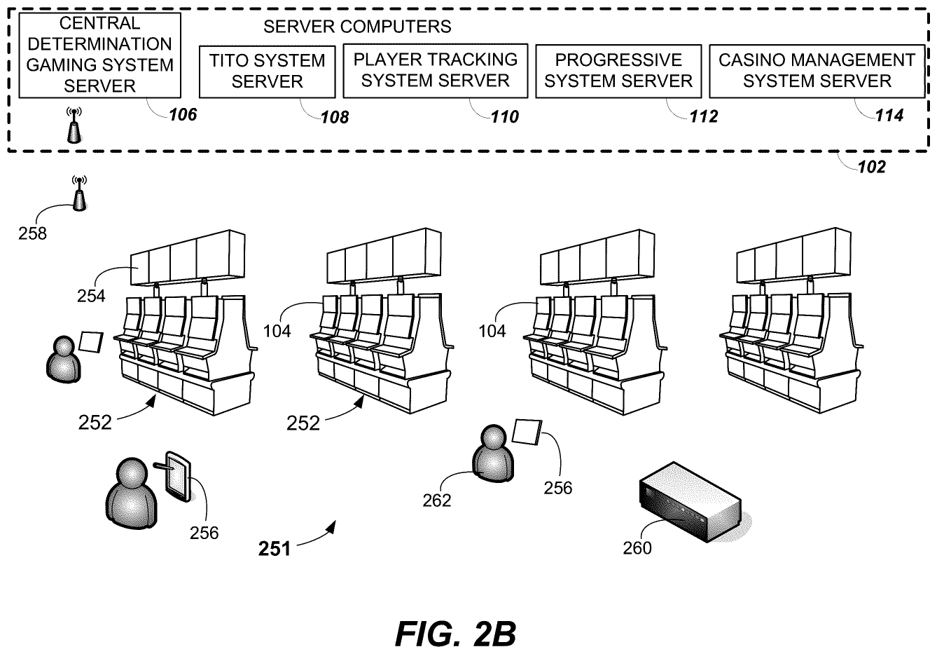

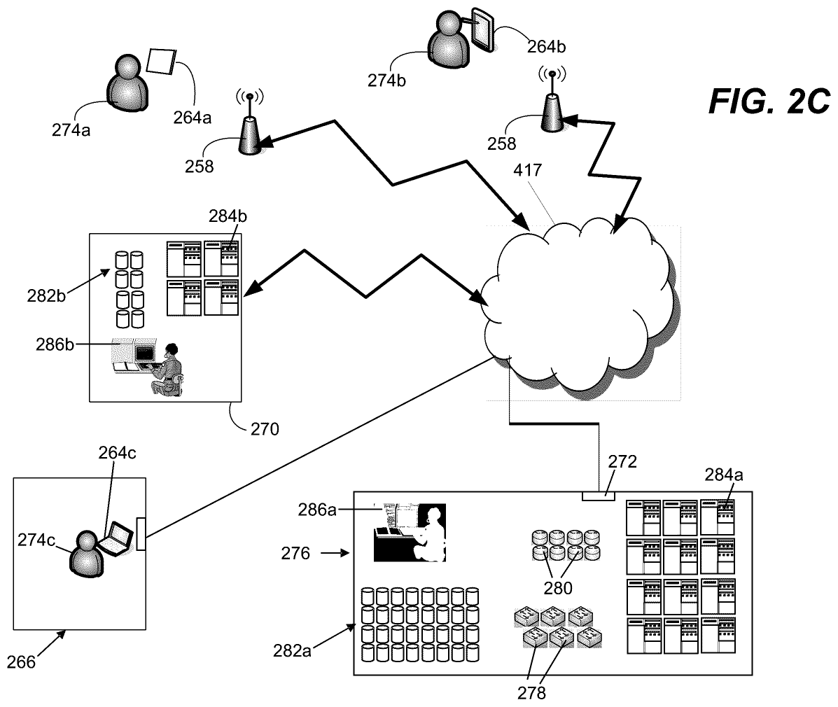

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play, or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random-access memory (DRAM), magnetic random-access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. In general, volatility refers to the frequency or probability of an event such as a special mode, a payout, etc. For example, for a target level of RTP, a higher-volatility game may have a lower payout most of the time with an occasional bonus having a very high payout, while a lower-volatility game has a steadier payout with more frequent bonuses of smaller amounts. Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types, and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

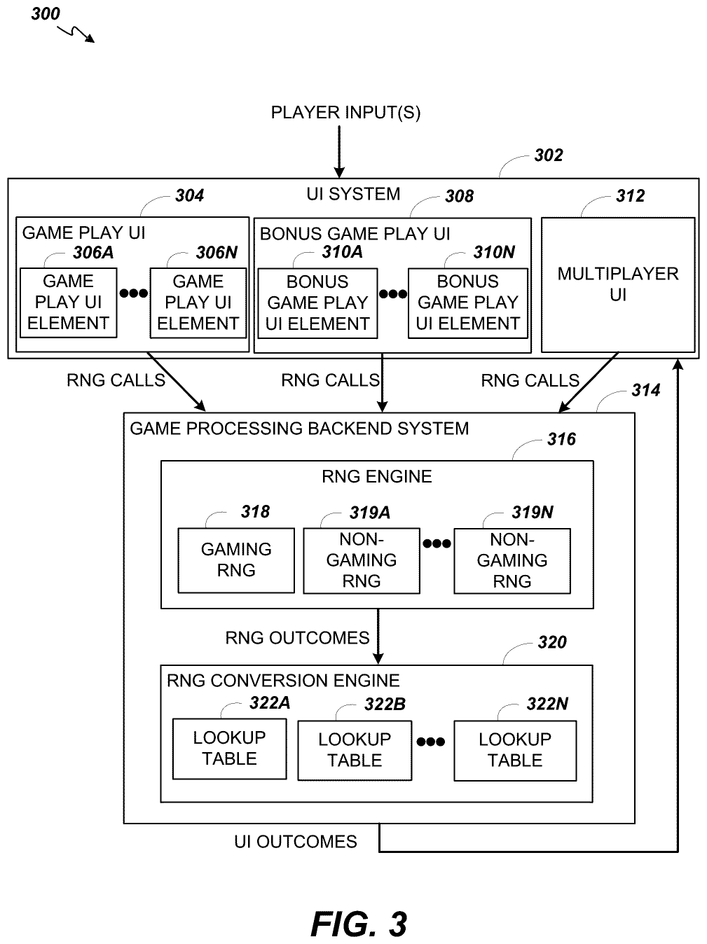

FIG. 3 illustrates, in block diagram form, an implementation of a game processing architecture 300 that implements a game processing pipeline for the play of a game in accordance with various implementations described herein. As shown in FIG. 3, the gaming processing pipeline starts with a UI system 302 receiving one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, or additionally, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

In some embodiments, the UI outcome received by the UI system 302 may be related to a bonus game. The bonus game may be an equity-based bonus game. By way of a non-limiting example, the equity-based bonus game may award a different winning to each player based on an equity that has been built by each player based on their gaming activities during a gameplay. In other words, a probability of winning a jackpot for each player in a bonus game may depend on an amount contributed (or a bet wagered) by each player during their respective base game play. As a result, the more that player contributes during the base game play, the player may have a better probability of winning in the bonus. In some examples, the layer may also be assigned a higher multiplier value on potential winning in the bonus game. By way of a non-limiting example, if a player wagering a minimum bet during the base game is awarded a particular bonus reward during the bonus game, the player may be awarded 5 times the particular bonus reward during the bonus game if the player wagered 5 times the minimum bet during the base game.

In some embodiments, the equity-based bonus game may be implemented on an EGM which triggers a bonus game. By way of a non-limiting example, the bonus game may be triggered as a hold and spin bonus game when symbols in a predetermined pattern may appear during a base game. For example, the predetermined pattern may be according to a certain number of specific symbols, and/or a set of specific symbols appearing at a predetermined positions in an active game display area or reels. The set of specific symbols may be cash-on-reels symbols, and at least 6 or more cash-on-reels symbols when appear on the reels during a base game play, a bonus game may be triggered.

The base game, as referenced herein, may be a game that is played directly between a player and an EGM of a set of EGMs. The set of EGMs may include a specific number of EGMS, for example, 5 EGMs. During a bonus game, each EGM or the set of EGMs may act as a reel and showing a particular number of symbols, for example, 3 symbols. In other words, if the set of EGMs includes 5 EGMs, during the bonus game, each EGM displaying 3 symbols may form or act as a 3×5 reel matrix, which makes the bonus game a community gaming.

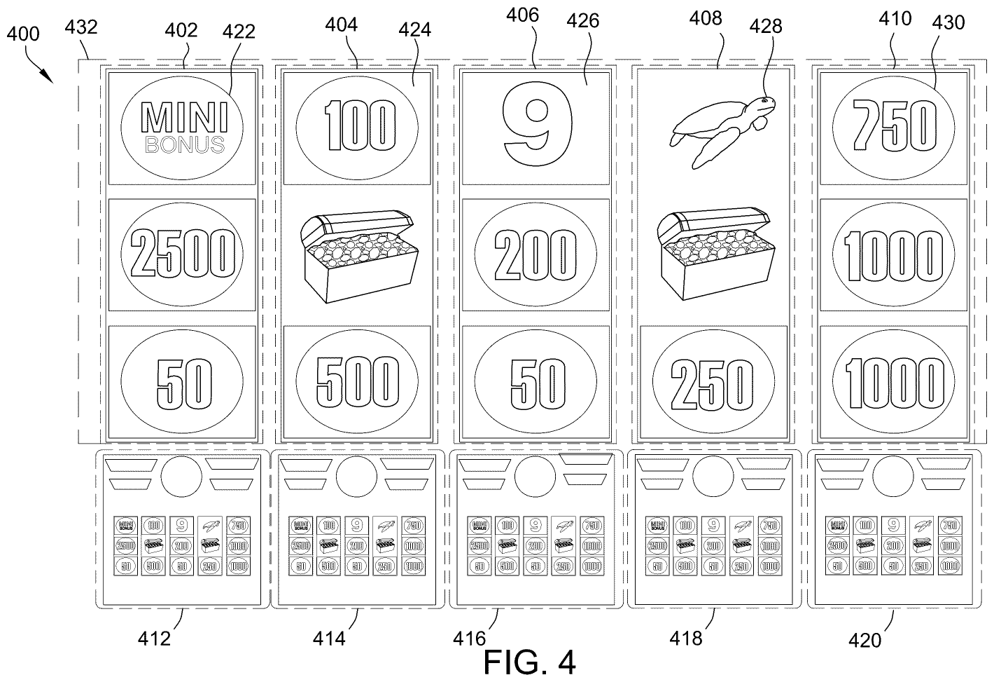

FIG. 4 illustrates a set of example EGMs 400 configured to execute a community gaming game with a bonus game and display the bonus game, in accordance with embodiments of the present disclosure. The set of EGMs 400 includes more than one EGM, for example, an EGM1 402, an EGM2 404, an EGM3 406, an EGM4 408, and an EGM5 410. Even though only five EGMs are in the set of EGMs in FIG. 4, there may be any number of EGMs, for example, 7, 10, 15, or 20, in the set of EGMs. Each EGM 402, 404, 406, 408, and 410 of the set of EGMs 400 may have a respective active display area 412, 414, 416, 418, and 420, for displaying symbols on reels during a base game and/or for displaying all reels from the set of EGMs when in the bonus game. As described herein, the base game may be directly between a player and a specific EGM such as the EGM 402, 404, 406, 408, or 410. Players on each of EGM 402, 404, 406, 408, or 410 are playing a base game specific to their EGM, respectively.

Upon the certain number of (e.g., three, four, five or six or some other number) specific symbols (e.g., cash-on-reels symbols) appearing on the reels in the respective active display area 412, 414, 416, 418, or 420 during a base game, a bonus game (e.g., a community bonus game) may be initiated or triggered. Any one of EGMs 402, 404, 406, 408, or 410 can trigger the bonus game. During the community bonus game, each EGM 402, 404, 406, 408, and 410 of the set of EGMs may be linked, and display areas 422, 424, 426, 428, and 430 of the EGMs 402, 404, 406, 408, and 410, respectively, may form an active display area 432 of the community bonus game. Alternatively, or additionally, each EGM 402, 404, 406, 408, and 410 of the set of EGMs may be linked even when the community bonus game is not triggered, but display areas 422, 424, 426, 428, and 430 of the EGMs 402, 404, 406, 408, and 410, respectively, may form an active display area 432 of the community bonus game when the community bonus game is triggered or initiated. The active display area 432 of the community bonus game may, therefore, act as a 3×5 reel matrix. During the community bonus game, display areas 412, 414, 416, 418, and 420 may display a miniature version of the display area 432 so that each player can view an entire bank of linked EGM displays on a display screen of a single EGM.

In some embodiments, the community bonus game may be an equity-based community bonus game in which some percentage of a player's bet or wager (also referenced herein as an equity) may be placed in a reserve to have some or all of the reserved bet returned back to the player later during the game play. The player's equity may be paid back in part or in full. In some examples, the player's equity may be combined with one or more other players' equity, and using an RNG, each player may be awarded differently from the combined equity. Accordingly, a player may receive none of the combined equity, some part of the combined equity, or the combined equity in its entirety. In other words, a player may receive none of, some of, all of, or more than the player's reserved bet or wager.

In some embodiments, an EGM is configured for a community bonus game, such as an equity-based community bonus game, and may display a notification in a display area of the EGM that the EGM is configured for the community bonus game, such as the equity-based community bonus game. A player may be asked to create a registration entry so that the EGM may save the player's data and gaming activities on the EGM. By way of a non-limiting example, the registration entry may include a screen name and a phone number of the player. The screen name may be selected by the player. The registration entry may include a color and/or a symbol that the player may select to identifying the player during the community bonus game. Additionally, or alternatively, the registration entry may include an avatar selected by the player or created by the player, which may be displayed during the community bonus game to identifying a specific symbol position assigned to the player, as described herein.

For an EGM on which the equity-based community bonus game feature is available, the player may (i) continue to play the game until their equity in the game expires or is awarded in some amount, or (ii) exit the game while equity is still invested in the game. In some embodiments, the community bonus game, such as the equity-based community bonus game, may notify one or more players, who are not at the EGMs (no longer playing the game) and have become eligible to participate in the equity-based community bonus game post exiting the game. The one or more players, who are not at the EGM, may be notified on their respective client device (e.g., a phone, a smartphone, a tablet, a smartwatch, a laptop, a computer, a smart glass, and so on) that the player has become eligible to participate in the equity-based community bonus game and/or are eligible to collect the available bonus which includes some or all of their equity in the game. The player can then return to the EGM or a kiosk to claim their reward after it is determined that this player has won an award from the equity-based game.

In some embodiments, during the base game play, as a player spins reels on an EGM (such as the EGM 402, 404, 406, 408, and/or 410), the player may accumulate or accrue time to trigger a bonus game. Each EGM 402, 404, 406, 408, and 410 of the set of EGMs may include a timer allowing a player of the EGM to qualify for a community bonus game. As a player initiate spinning of the reels on an EGM, the player may earn time with each spin initiated.

In some examples, with each spin, the player may earn 10 seconds, 20 seconds, or 30 seconds, and so on, to qualify for the community bonus game. The time that the player may be awarded may depend on an amount of a bet wagered by the player, and/or a frequency of the player's spinning of the reels. The time available to the player to qualify for the community bonus game may be visually displayed as an energy meter, a counter, and/or an energy/lightning animation inside an area on the EGM. By way of a non-limiting example, the energy meter, the counter, and/or the animation area may be displayed in display areas 422, 424, 426, 428, and 430 of the EGMs 402, 404, 406, 408, and 410, respectively.

Accordingly, the energy meter, the counter, and/or the animation area may represent an available time to the player to qualify for the community bonus game. The time available to the player to qualify for the community bonus game may diminish or drain over time. Only when the player has sufficient time (or energy) available, the player may get qualified if a bonus game is triggered. The player may keep sufficient time (or energy) available by actively spinning the reels and updating the available energy (or time) as the available energy (or time) continues diminishing or draining. Although the example provided here describes an amount of time for qualifying for a bonus game, another embodiment may include being awarded free spins that can be used during a bonus game.

In some embodiments, the time (or energy) available to qualify for the bonus game may be capped to a maximum value. By way of an example, the maximum value may be dynamically and/or randomly updated. A player for whom the time (or energy) available to quality for the bonus game is capped to the maximum value, the player may be assigned or rewarded more than 1 position during the bonus game based on the player's continued gaming activity. The player may be notified that the time (or energy) has capped to the maximum value and the player is being rewarded with more than 1 position during the bonus game using a visual aid (e.g., on a display of an EGM).

In some embodiments, by way of a non-limiting example, accrual of time may be replaced with a spin count. Each player may be awarded a spin count of 1 if the player attaches or wagers a minimum required bet value to a spin. As the player attaches or wagers a larger bet value to a spin, the player may be awarded more than 1 spin count toward qualifying for the bonus game. Then, for each spin by any player on any EGM (e.g., an EGM 402, 404, 406, 408, or 410) of the set of EGMs for which a bonus game does not get triggered, each player's spin count may be reduced by a certain number (e.g., 1 count or 2 counts).

As described herein, which symbols appear on an EGM is randomly determined by the game processing backend system 314. As the certain number (e.g., six) of specific symbols (e.g., cash-on-reel symbols) appear during a base game on any EGM 402, 404, 406, 408, or 410 of the set of EGMs, ongoing base games on all EGMs 402, 404, 406, 408, and 410 of the set of EGMs may freeze and transition to the bonus game.

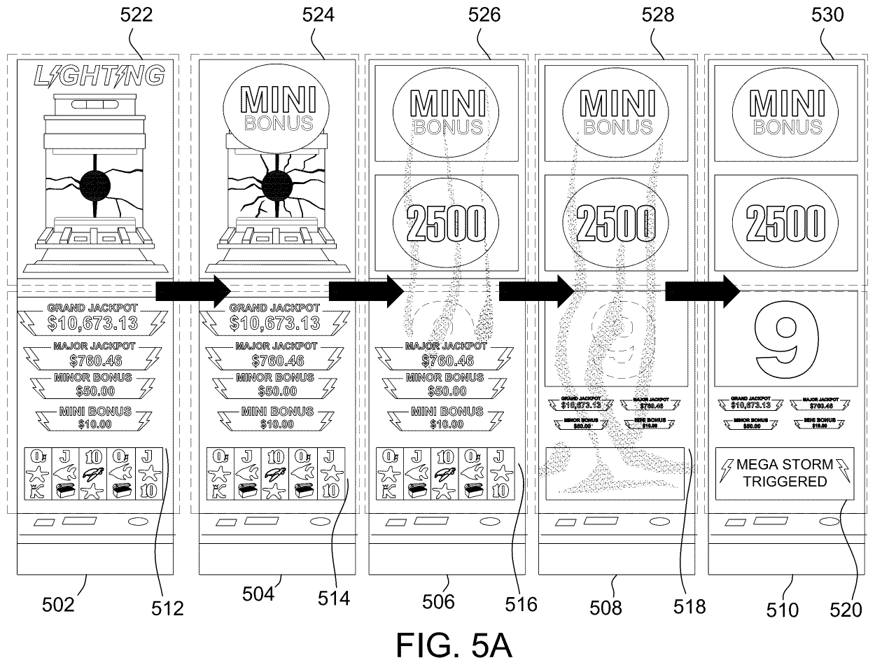

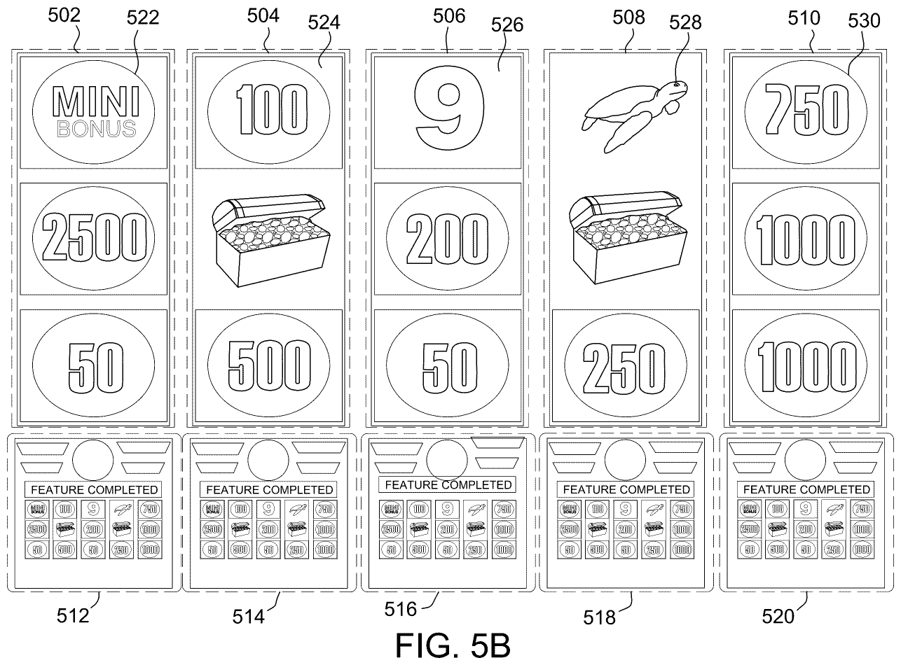

FIGS. 5A and 5B illustrate transition of an EGM from a base game play to a bonus game displayed on display devices of a set of EGMs, in accordance with embodiments of the present disclosure. As shown in FIG. 5A, a set of EGMs may include more than one EGM such as, an EGM 502, an EGM 504, an EGM 506, an EGM 508, and an EGM 510, and so on. Even though, only 5 EGMs are shown in the set of EGMs in FIG. 5, there may be any number of EGMs in the set of EGMs. During a base game play, a lower section (or a first section) of a display of each EGM, which is shown as 512, 514, 516, 518, and 520, may correspond with an active gaming area in which reels are spun and symbols are displayed. An upper section (or a second section) of the display of each EGM, which is shown as 522, 524, 526, 528, and 530, may display the energy meter, the counter, and/or the energy/lightning animation area on the EGM, as described herein.

As the bonus game is triggered, an ongoing base game on each EGM 502, 504, 506, 508, and 510, may freeze, and the upper section (or the second section) of the display of each EGM 502, 504, 506, 508, and 510, may be reconfigured or rearranged to display bonus symbols, as shown in FIG. 5B. By way of a non-limiting example, for the five EGMs 502, 504, 506, 508, and 510, the bonus symbols may be displayed on three-by-five (3×5) reel matrix. In other words, the upper section (or the second section) of the display of each EGM 502, 504, 506, 508, and 510 may display 3 bonus symbols. During the bonus game, display in the lower section (or the first section) of the display of each EGM 502, 504, 506, 508, and 510 may be in a locked state with the community bonus game showing the bonus game display in a miniature version as described herein, or may be in a locked state to display a basic game screen corresponding to each respective EGM of EGMs 502, 504, 506, 508, and/or 510.

In some embodiments, by way of a non-limiting example, during a bonus game, 3 free spins may be awarded. With each spin, a number of remaining spins is decreased by 1. During a spin, if a bonus symbol appears or hits on any of the 3×5 reel matrix, a count of the free spins may be reset to 3 again. When the last free spin is over, and no bonus symbol is hit during the last free spin, the bonus game is complete. The bonus symbols may include credit values and/or jackpot values. A player may be awarded a grand jackpot if all symbol positions are filled with bonus symbols.

During the community bonus game, more than one player may be players of the same game during the bonus game play. Once the bonus game is complete, all the players of the community bonus game, may be awarded a credit value (e.g., an equity) multiplied by their respective bet multiplier plus any jackpot, if applicable. A total number of players during the bonus game may be more than 1 and maximum up to the number of reels during the bonus game. Accordingly, the maximum number of players during the community bonus game may be 15 for the set of EGMs shown herein in accordance with FIG. 4.

Each player's position on the bonus reels may be shown using a symbol, a color, and/or an avatar chosen by each player. Additionally, or alternatively, a player may be assigned more than one symbol position, as described herein. By way of a non-limiting example, one or more symbol positions may be assigned to a team of players. Each team of players may be identified using a particular color, symbol, image, and/or avatar.

In some embodiments, one or more EGM of a set of EGMs may be a mobile application or a web application executing on a player's client device. Multiple players may participate as a group, and/or a player may participate during the bonus game by back-betting with a group of current players playing on EGMs of the set of EGMs. A player, who left an EGM with their equity saved may be notified once the bonus game is triggered. Alternatively, or additionally, a player may check status of whether the bonus game is triggered or not using the mobile application or the web application.

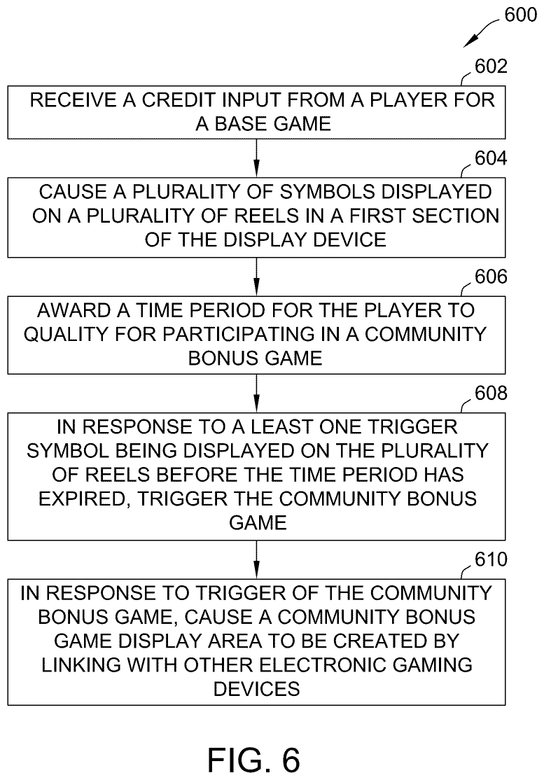

FIG. 6 illustrates an exemplary flow-chart 600 of method operations performed by an electronic gaming device (or an EGM), in accordance with some embodiments. The method operations may be performed by an electronic gaming device of a plurality of electronic gaming devices, where each electronic gaming device may include a display device, an interface device coupling the electronic gaming device with other electronic gaming devices of the plurality of electronic gaming devices and an electronic gaming application server. Each electronic gaming device may also include a memory device that is configured to store instructions and/or game data including gaming activities of a plurality of players on the electronic gaming device. Each electronic gaming device may also include a game controller including a processor that is configured to execute the instructions stored in the memory device and/or instructions received from the electronic gaming server. One or more instructions received from the electronic gaming application server and/or the electronic gaming device may be generated using at least one RNG.

At 602, the electronic gaming device may receive a credit input from a player for a base game. The credit input from the player may be cash, tokens, and/or credits, or in other forms. At 604, in response to receiving an input for initiating the base game, a plurality of symbols may be displayed on a plurality of reels. The plurality of symbols may be displayed in a first section of the display device. One or more symbols of the plurality of symbols may be displayed on one or more reels of the plurality of reels. By way of a non-limiting example, the plurality of reels may be mechanical reels, or electronic reels (which may be displayed as an overlay over other display content). The plurality of reels may be displayed on the first section, for example, a bottom half or a bottom third of the display device.

At 606, based upon an amount of the credit input received from the player, the player may be awarded time period or energy to qualify for participating in a community bonus game. As described herein, if the amount of the credit input is a minimum bet, the player may be awarded, for example, 10 seconds, to qualify for participating in the community bonus game. In some embodiments, instead of time period, an energy, for example, a number of spins, may be awarded to the player to qualify for the community bonus game. The time period, and/or the energy may continue diminishing, as described herein.

In response to at least one trigger symbol being displayed on the plurality of the reels, before the accrued time period has expired or energy has diminished below a minimum threshold value, the community bonus game may be triggered at 608. By way of a non-limiting example, the minimum threshold value may be 0 seconds or 0 spins. The trigger symbol may be a cash-on-reel symbol. In some embodiments, and by way of a non-limiting example, the community bonus game may be triggered when a predetermined number of trigger symbols (for example 6 trigger symbols) land on the plurality of reels before the accrued time period has expired or energy has diminished below the minimum threshold value.

At 610, in response to triggering of the community bonus game, a community bonus game display area may be created. By way of a non-limiting example, the community bonus game display area may be created by linking each electronic gaming device of the plurality of electronic gaming devices and using a portion of the display device (e.g., top half or a top third of the display device) of each electronic gaming device of the plurality of electronic gaming devices. A specific number of symbol positions (e.g., 3 symbol positions) may be displayed in the portion of the display device used to create the community bonus game display area. Accordingly, if a total count of electronic gaming devices in the plurality of electronic gaming devices is 5, then there may be 3 times 5 (3×5), or total 15 symbol positions.

In some embodiments, all current and past players who qualify to participate in the community bonus game may be identified and notified. The past players, as described herein, may refer to players who has left game of the electronic gaming device with their accrued time or energy to qualify to participate in the community bonus game before it expires or diminishes below the minimum threshold value, as described herein. Upon being notified, a player may either return to the electronic gaming device and/or may check status of the community bonus game on the mobile application or a web application, as described herein. The player qualified to participate in the community bonus game may be assigned one or more symbol positions from the specific number of symbol positions described herein. A symbol position assigned to one player may be visually distinguishable from another symbol position assigned to another player. By way of a non-limiting example, one or more symbol positions may be assigned to a group of one or more players. One or more symbol positions assigned to one group of players may be visually distinguishable from one or more symbol positions assigned to another group of players.

In some embodiments, one or more symbols from the plurality of symbols may be displayed in one or more symbol positions of the specific number of symbol positions. The one or more symbol positions in which the one or more symbols may be displayed during each spin of the community bonus game may be on one or more electronic gaming devices of the plurality of electronic gaming devices. By way of a non-limiting examples, during each spin of the community bonus game, a new symbol may be displayed in each symbol position, or a previously displayed symbol in a symbol position may be removed. Alternatively, or additionally, during each spin of the community bonus game, a new symbol may be displayed in a symbol position in which no symbol has landed during previous spins. In some examples, during the community bonus game, a certain number of free spins (e.g., 3 free spins) may be available. During each spin, if a symbol, which is related to a bonus symbol, lands on any symbol position, or a particular symbol position, the number of available free spins may be reset to an initial value (e.g., 3 free spins).

In some embodiments, upon completion of the available free spins, a symbol landed on each symbol position may be identified. As described herein, at least one symbol position may be assigned to a player qualified for participating in the community bonus game. And, therefore, the symbol landed on each symbol position may be used to determine an amount of winning for each player who qualified and participated in the community bonus game. The amount of winning may be determined in accordance with a credit symbol and/or a jackpot symbol that landed on the one or more symbol positions assigned to the player.

Accordingly, various embodiments, as described herein, provide significant improvement by increasing a player's RTP from about 30% to 40%, and/or increasing a player's probability to win during a bonus game, even after a player has left game of the electronic gaming device. In some embodiments, and by way of a non-limiting example, a player may have the equity reserved or saved for a certain amount of time after leaving the electronic gaming device. If a bonus game triggers while the certain amount of time for which the player's equity is reserved has not lapsed, the player may participate in the bonus game. Alternatively, or additionally, a player may sell the equity for an expected monetary value and chose not to participate in the bonus game even if the bonus game triggers prior to lapse of the amount of time for which the equity may have been saved. The player may also cash out the equity in form of one or more bonus or free spins, during the base game play, based on the amount of equity.

In some embodiments, a player may earn a symbol position on a grid of a plurality of symbol positions for a future bonus game. Upon each symbol position of the grid being assigned to one or more players, the bonus game may begin. The bonus game may include multiple rounds, and during each round one or more players may be eliminated and/or added. Rounds of the bonus game may continue until there is only one player, who may be awarded the highest prize.

In some embodiments, a base game play and a bonus game may be based on a lucky draw card game in which a card deck may include 52 cards and five wilds. The card deck may include a different number of wilds too. When all of the cards have been dealt, a bonus game may be triggered. During the bonus game, the cards may be shuffled, and a winning hand may be drawn. The winning hand may determine how much is won, and one or more players whose cards get drawn, may be awarded the winning. A player may get multiple cards, and the wild card may pay the highest winning. Similar to the equity-based community game, as described herein, in accordance with some embodiments, each player's progress may be saved for a player to participate in a lucky draw bonus game while the player is away. The player may pick up his/her win by accessing an electronic gaming device that is associated with the lucky draw card game. By way of an example, instead of an electronic gaming device, a player may play the lucky draw card game using a mobile application or a web application executing on the player's client device.

In some embodiments, the equity-based community bonus game may be a blackout keno game, which is a persistent state game saving progress of each player of the keno game. In the blackout keno game, a player may place a side bet on, for example, 3 keno cards. The 3 keno cards may be of 3 different colors or themes. Each player may be randomly awarded symbol positions on those keno cards, and the goal is to fill in all the symbol positions. Initially, a prize for filling in all the symbol positions is high, and the longer it takes to fill in the symbol positions, the prize may be keep reducing. As a result, the player may need to decide if it is worth to continue, or reset, the blackout keno cards, and start over the game. By way of an example, instead of an electronic gaming device, a player may play the blackout keno game using a mobile application or a web application executing on the player's client device.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming machine (EGM) of a plurality of EGMs, the EGM comprising:
a display device;
an interface device coupling the EGM with other EGMs of the plurality of EGMs and an electronic gaming server;
a memory device for storing computer executable instructions; and
a game controller comprising a processor configured to execute the instructions stored in the memory device, which, when executed, cause the game controller to:
receive a credit input from a player for a base game;
in response to receiving an input for initiating the base game, cause to be displayed a plurality of symbols on a plurality of reels, the plurality of symbols displayed in a first section of the display device;
based upon an amount of the credit input, award a time period for the player to qualify for participating in a community bonus game;
in response to at least one trigger symbol being displayed on the plurality of reels before the time period has expired, trigger the community bonus game; and
in response to triggering of the community bonus game, cause a community bonus game display area to be created by linking with the other EGMs of the plurality of EGMs, the community bonus game display area created from a second section of the display device of each EGM of the plurality of EGMs, the second section of the display device of each EGM of the plurality of EGMs including a predefined number of symbol positions.

2. The EGM of claim 1, wherein the instructions, which, when executed, further cause the game controller to:
identify all current and past players qualified for the community bonus game, a qualified player being a current or past player having an assigned time period for the community bonus game that has not yet expired;
cause display of a set of symbols in the symbol positions of the community bonus display areas of the plurality of EGMs during one or more spins of the bonus game;
upon completion of the bonus game, identify symbols displayed within the community bonus display areas of the plurality of EGMs; and
based on the identified symbols, determine an amount of an award for each qualified player of the community bonus game.

3. The EGM of claim 2, wherein the instructions, which, when executed, further cause the game controller to:
determine a bet multiplier in accordance with the credit input received from the player; and
determine the amount of the award for the player based on a credit value associated with a symbol landed on a symbol position of the symbol positions of the community bonus display areas assigned to the player and the determined bet multiplier.

4. The EGM of claim 3, wherein:
the player is assigned more than one symbol positions, and
each symbol position of the more than one symbol positions assigned to the player is on the same EGM or different EGMs of the plurality of EGMs.

5. The EGM of claim 3, wherein the symbol position assigned to the player is visually distinguishable from another symbol position assigned to another player.

6. The EGM of claim 2, wherein the plurality of symbols includes at least: a bonus symbol, a credit symbol, or a jackpot symbol.

7. The EGM of claim 6, wherein the instructions, which, when executed, further cause the game controller to reset a value of available number of free spins when the bonus symbol lands on a symbol position of the symbol positions of the community bonus display areas.

8. The EGM of claim 7, wherein the available number of free spins is three spins.

9. The EGM of claim 1, wherein the instructions, which, when executed, further cause the game controller to display the time period awarded to the player to qualify for participating in the community bonus game in a second section of the display device.

10. The EGM of claim 1, wherein the instructions, which, when executed, further cause the game controller to freeze or suspend the base game and the plurality of symbols displayed in the first section of the display device upon triggering of the community bonus game.

11. A computer-implemented method, comprising:
receiving a credit input from a player for a base game at an electronic gaming device, the electronic gaming device is coupled with other electronic gaming devices of a plurality of electronic gaming devices via an interface device;
in response to receiving an input for initiating the base game, causing to be displayed a plurality of symbols on a plurality of reels, the plurality of symbols displayed in a first section of a display device of the electronic gaming device;
based upon an amount of the credit input, awarding an energy for accrual for the player to qualify for participating in a community bonus game;
in response to at least one trigger symbol being displayed on the plurality of reels before the accrued energy has diminished below a threshold value, triggering the community bonus game; and
in response to triggering of the community bonus game, causing a community bonus game display area to be created by linking with the other electronic gaming devices of the plurality of electronic gaming devices, the community bonus game display area created from a second section of the display device of each electronic gaming device of the plurality of electronic gaming devices, the second section of the display device of each electronic gaming device of the plurality of electronic gaming devices including a predefined number of symbol positions.

12. The computer-implemented method of claim 11, further comprising:
identifying all current and past players qualified for the community bonus game, a qualified player being a current or past player having an accrued energy for the community bonus game that has not yet diminished below the threshold value;
causing display of a set of symbols in the symbol positions of the community bonus display areas of the plurality of electronic gaming devices during one or more spins of the bonus game;
upon completion of the bonus game, identifying symbols displayed within the community bonus display areas of the plurality of electronic gaming devices; and
based on the identified symbols, determining an amount of an award for each qualified player of the community bonus game.

13. The computer-implemented method of claim 12, further comprising:
determining a bet multiplier in accordance with the credit input received from the player; and
determining the amount of the award for the player based on a credit value associated with a symbol landed on a symbol position of the symbol positions of the community bonus display areas assigned to the player and the determined bet multiplier.

14. The computer-implemented method of claim 13, wherein:
the player is assigned more than one symbol positions, and each symbol position of the more than one symbol positions assigned to the player is on the same EGM or different EGMs of the plurality of EGMs.

15. The computer-implemented method of claim 13, wherein the symbol position assigned to the player is visually distinguishable from another symbol position assigned to another player.

16. The computer-implemented method of claim 12, wherein the plurality of symbols includes at least: a bonus symbol, a credit symbol, or a jackpot symbol.

17. The computer-implemented method of claim 16, further comprising resetting a value of available number of free spins when the bonus symbol lands on a symbol position of the symbol positions of the community bonus display areas.

18. The computer-implemented method of claim 11, further comprising freezing or suspending the base game and the plurality of symbols displayed in the first section of the display device upon triggering of the community bonus game.

19. An electronic gaming application server communicatively coupled with a plurality of electronic gaming devices, the electronic gaming application server comprising:
a memory device storing instructions;
at least one random number generator (RNG); and
a game controller comprising a processor configured to execute the instructions stored in the memory device, which, when executed, cause the game controller to:
in response to receiving an input for initiating a base game at an electronic gaming device of the plurality of electronic gaming devices, cause to be displayed a plurality of symbols on a plurality of reels, the plurality of symbols displayed in a first section of a display device of the electronic gaming device;
based upon an amount of credit input received from a player at the electronic gaming device, cause awarding of an energy for accrual for the player to qualify for participating in a community bonus game;
in response to at least one trigger symbol being displayed on the plurality of reels before the accrued energy has diminished below a threshold value, cause triggering of the community bonus game; and
in response to triggering of the community bonus game, cause a community bonus game display area to be created by linking with the other electronic gaming devices of the plurality of electronic gaming devices, the community bonus game display area created from a second section of the display device of each electronic gaming device of the plurality of electronic gaming devices, the second section of the display device of each electronic gaming device of the plurality of electronic gaming devices including a predefined number of symbol positions.

20. The electronic gaming application server of claim 19, wherein the instructions, which, when executed, further cause the game controller to:
identify all current and past players qualified for the community bonus game, a qualified player being a current or past player having an assigned time period for the community bonus game that has not yet expired;
cause display of a set of symbols in the symbol positions of the community bonus display areas of the plurality of EGMs during one or more spins of the bonus game;
upon completion of the bonus game, identify symbols displayed within the community bonus display areas of the plurality of EGMs; and
based on the identified symbols, determine an amount of an award for each qualified player of the community bonus game.
